(19) United States
(12) Patent Application Publication
(10) Pub. No.: US 2018/0089637 A1
(43) Pub. Date: Mar. 29, 2018

(54) FRAMEWORK FOR INDUSTRIAL ASSET REPAIR RECOMMENDATIONS

(71) Applicant: General Electric Company, Schenectady, NY (US)

(72) Inventors: Arun Karthi SUBRAMANIYAN, Niskayuna, NY (US); Liping WANG, Schenectady, NY (US); Ankur SRIVASTAVA, Niskayuna, NY (US)

(21) Appl. No.: 15/275,741

(22) Filed: Sep. 26, 2016

(51) Int. Cl. G06Q 10/00; G06Q 10/06

(52) U.S. Cl. CPC G06Q 10/20; G06Q 10/06375

(57) ABSTRACT

According to some embodiments, information associated with operation of a set of industrial assets, including pre-repair and post-repair performance metrics for the industrial assets, may be received. A reparability framework processing unit may execute a similarity analysis on the pre-repair and post-repair performance metrics for the industrial assets to probabilistically quantify improvement in performance metrics as a result of a repair. The reparability framework processing unit may also predict an effect of a repair on a specific industrial asset based at least in the quantified improvement in performance metrics. The reparability framework processing unit may then automatically generate at least one asset repair recommendation for the specific industrial asset, based at least in part on the predicted effect, and transmit information associated with the at least one asset repair recommendation for the specific industrial asset.

### BACKGROUND

It may be desirable to manage an industrial asset, or monitored system, by monitoring performance and/or predicting faults that might occur in connection operation of the asset. For example, such monitoring might indicate that preventive maintenance should be performed on the asset to improve performance and/or to prevent future failures. To facilitate management of industrial assets, an asset-specific diagnosis system may receive evidence (e.g., sensed by sensors during operation of the asset) and automatically generate a recommendation based on rules and logic that were created by an experienced manager or operator using his or her expert judgement (and, in some cases, a repair manual). Such an approach, however, can be an expensive, time-consuming, and error prone process. For example, even a manager with many years of experience might define rules that result in unnecessary maintenance and/or that fail to detect certain types of performance degradation—especially when the industrial asset is complex and/or there are a substantial number of sources of information (e.g., sensors) and/or types of faults that may occur. It would therefore be desirable to provide systems and methods to generate repair recommendations for a specific industrial asset in an automatic and accurate manner.

### SUMMARY

According to some embodiments, information associated with operation of a set of industrial assets, including pre-repair and post-repair performance metrics for the industrial assets, may be received. A reparability framework processing unit may execute a similarity analysis on the pre-repair and post-repair performance metrics for the industrial assets to probabilistically quantify improvement in performance metrics as a result of a repair. The reparability framework processing unit may also predict an effect of a repair on a specific industrial asset based at least in the quantified improvement in performance metrics. The reparability framework processing unit may then automatically generate at least one asset repair recommendation for the specific industrial asset, based at least in part on the predicted effect, and transmit information associated with the at least one asset repair recommendation for the specific industrial asset.

Some embodiments comprise: means for receiving information associated with operation of a set of industrial assets, including pre-repair and post-repair performance metrics for the industrial assets; means for executing, by a reparability framework processing unit, a similarity analysis on the pre-repair and post-repair performance metrics for the industrial assets to probabilistically quantify improvement in performance metrics as a result of a repair; means for predicting an effect of a repair on a specific industrial asset based at least in the quantified improvement in performance metrics; means for automatically generating at least one asset repair recommendation for the specific industrial asset based at least in part on the predicted effect; and means for transmitting information associated with the at least one asset repair recommendation for the specific industrial asset.

Some technical advantages of some embodiments disclosed herein are improved systems and methods to generate repair recommendations for a specific industrial asset in an automatic and accurate manner.

### BRIEF DESCRIPTION OF THE DRAWINGS

FIG. 1 is a high-level architecture of a system in accordance with some embodiments.

FIG. 2 illustrates a method that might be performed according to some embodiments.

FIG. 3 illustrates an asset management system in accordance with some embodiments.

FIG. 4 is an example of a reparability framework according to some embodiments.

FIG. 5 illustrates information associated with a similarity analysis in accordance with some embodiments.

FIG. 6 illustrates repair optimization according to some embodiments.

FIG. 7 illustrates an interactive graphical user interface Bayesian estimation display according to some embodiments.

FIG. 8 is block diagram of a reparability framework platform according to some embodiments of the present invention.

FIG. 9 is a tabular portion of a reparability database according to some embodiments.

FIG. 10 illustrates an interactive handheld graphical user interface display according to some embodiments.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

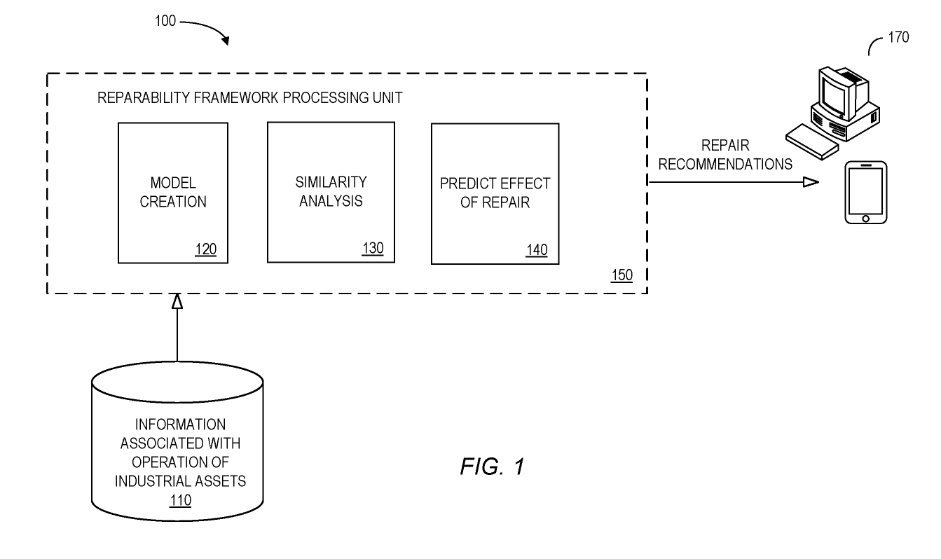

FIG. 1 is a high-level architecture of a system 100 in accordance with some embodiments. The system 100 includes an information associated with operation of industrial assets database 110 that provides data to a reparability framework processing unit 150. Data in the information associated with operation of industrial assets database 110 might include, for example, one or more electronic files containing performance metrics, maintenance history, a structured textual description of the industrial asset, etc.

The reparability framework processing unit 150 may, according to some embodiments, access the information associated with operation of industrial assets database 110 and utilize a diagnosis model creation process 130 to automatically create a similarity analysis 130 and predict effect of repair 140 models for an industrial asset. The asset similarity analysis 130 and predict effect of repair 140 models may then be used to generate repair recommendations based on evidenced observations (e.g., data sensed by sensors proximate to the industrial asset). The repair recommendations might comprise, for example, alert messages that are transmitted to remote operator platforms 170 to let an operator managing the asset take repair or maintenance actions as appropriate. As used herein, the term “automatically” may refer to, for example, actions that can be performed with little or no human intervention.

As used herein, devices, including those associated with the reparability framework processing unit 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The reparability framework processing unit 150 may store information into and/or retrieve information from various data sources, such as the information associated with operation of industrial assets database 110 and/or operator platforms 170. The various data sources may be locally stored or reside remote from the reparability framework processing unit 150. Although a single reparability framework processing unit 150 is shown in FIG. 1, any number of such devices may be included. Moreover, various devices described herein might be combined according to embodiments of the present invention. For example, in some embodiments, the reparability framework processing unit 150 and one or more data sources might comprise a single apparatus. The reparability framework processing unit 150 function may be performed by a constellation of networked apparatuses, in a distributed processing or cloud-based architecture.

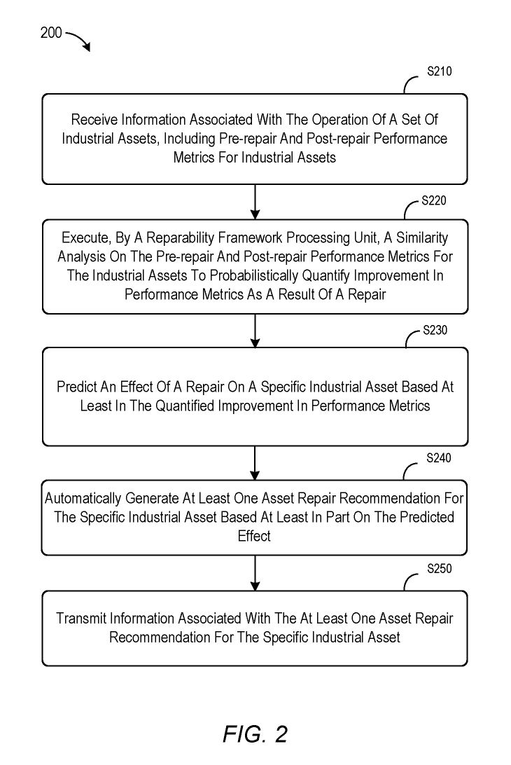

A user may access the system 100 via one of the user platforms 170 (e.g., a personal computer, tablet, or smartphone) to view or edit information about and/or manage the similarity analysis 130 and predict effect of repair 140 models in accordance with any of the embodiments described herein. According to some embodiments, an interactive graphical display interface may let an operator define and/or adjust certain parameters, provide or receive automatically generated repair recommendations (e.g., to improve industrial asset behavior), etc. For example, FIG. 2 illustrates a method 200 that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, information associated with operation of a set of industrial assets may be received, including pre-repair and post-repair performance metrics for the industrial assets. According to some embodiments, the information associated with the operation of the set of industrial assets includes Remote Monitoring Diagnostics (“RMD”) data. Other examples of data that might be included in the received information include distress modes, cost information, efficiency information, maintenance history data, sensor data, and/or data collected while an industrial asset is being repaired.

At S220, a reparability framework processing unit may execute a similarity analysis on the pre-repair and post-repair performance metrics for the industrial assets to probabilistically quantify improvement in performance metrics as a result of a repair.

At S230, the system may predict an effect of a repair on a specific industrial asset based at least in the quantified improvement in performance metrics. At S240, at least one asset repair recommendation for the specific industrial asset may be generated based at least in part on the predicted effect. For example, the at least one asset repair recommendation may be generated to maximize post-repair industrial asset performance metrics for the specific industrial asset at a minimized cost.

At S250, information associated with the at least one asset repair recommendation for the specific industrial asset may be transmitted (e.g., to a remote device associated with an industrial asset manager or repair shop). According to some embodiments, the transmitted information is a work-scope that includes information associated with a plurality of repair recommendations for the specific industrial asset. The work-scope may include, for example, a first repair recommendation and a second repair recommendation, the second repair recommendation being selected based at least in part on the generation of the first repair recommendation.

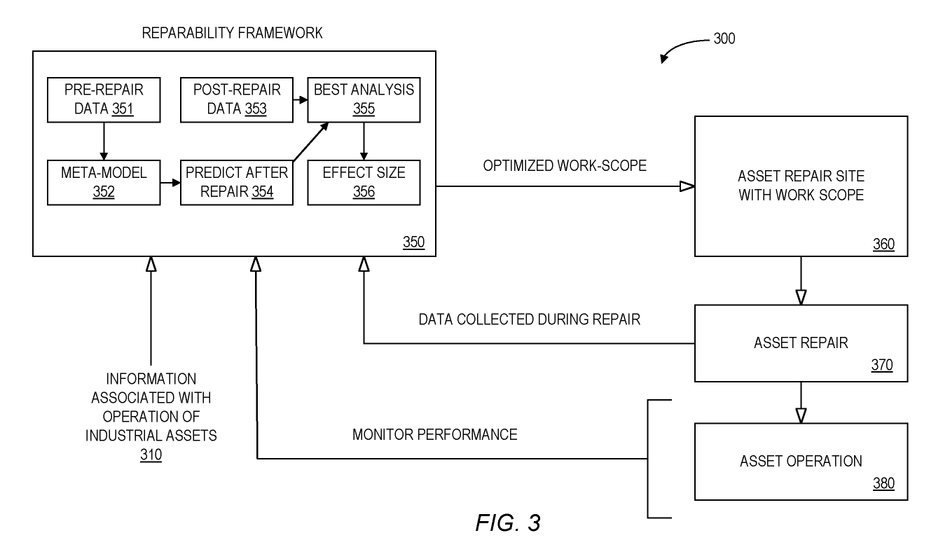

FIG. 3 illustrates an aviation asset management system 300 in accordance with some embodiments. As before, the system 300 includes information associated with operation of industrial assets 310 that may be provided to a reparability framework 350. Data in the information associated with operation of industrial assets 310 might include, for example, one or more electronic files containing performance metrics, sensor data, repair history data, etc. associated with an airplane, an airplane engine, an aircraft system, a power generation asset, etc.

The reparability framework 350 may, according to some embodiments, receive the information associated with operation of industrial assets 310 and use pre-repair data 351 to create a meta-model 352 (based on the historical data) that can predict after repair data 354. The reparability framework 350 can combine that with actual post-repair data 353 to perform a Bayesian Estimation (“BEST”) analysis 355 to generate an effect size 356. As used herein, the phrase “effect size” may refer to, for example, a value that represents a common statistical measure that is shared among data sets that may have a standard error so that the system can compute a weighted average of that common measure. Such weighting may, for example, take into consideration the sample sizes of the data sets and/or the quality of the data. Note that uncertainty in operating conditions may lead to an inaccurate comparison of sensor data. The meta-models 352, created with data before the repair may be compared to data after the repair via model predications.

The reparability framework 350 may then use this information to generate an optimized work-scope (e.g., containing multiple repair recommendations) that can be transmitted to an asset repair site 360. Data may be collected and provided to the reparability framework while the asset is being repaired 370, after which the industrial asset may resume normal operation 380 (and performance metrics may be monitored and fed back to the reparability framework 350).

As used herein, devices, including those associated with the reparability framework 350 and any other device described herein, may exchange information via any communication network. The reparability framework 350 may store information into and/or retrieve information from various data sources, such as the information associated with operation of industrial assets 310, data collected during asset repair 370, and/or information sensed during normal operation 380 of the asset. The various data sources may be locally stored or reside remote from the reparability framework 350. Although a single reparability framework 350 is shown in FIG. 3, any number of such devices may be included. Moreover, various devices described herein might be combined according to embodiments of the present invention. For example, in some embodiments, the reparability framework 350 and one or more data sources might comprise a single apparatus. The reparability framework 350 function may be performed by a constellation of networked apparatuses, in a distributed processing or cloud-based architecture.

Note that the reparability framework 350 might be associated with one or more adaptive neural network models to help determine the optimum repair methods give only the operational engine data. Note that an optimum repair method might maximize the difference between the pre-repair data and post-repair data. Moreover a meta-model may relate operational engine data with μ_{ES} and σ_{ES}² for the difference performance metrics. In some embodiments, if an effect size is associated with relatively high mean (μ_{ES}) and a relatively low standard deviation (σ_{ES}), if may be determined that a repair had a larger effect (otherwise it may be determined that the repair had a lesser effect).

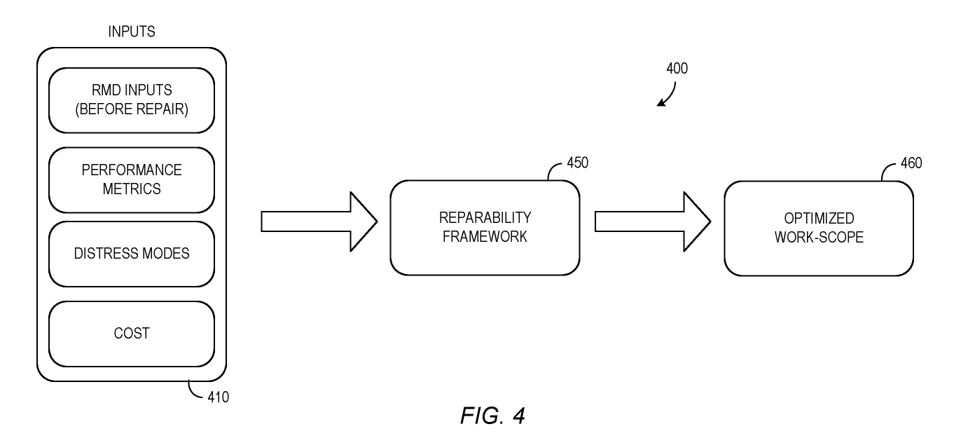

FIG. 4 is an example 400 of a reparability framework 450 according to some embodiments. A set of inputs 410, including RMD inputs (before a repair), performance metrics, distress modes (e.g., associated with types of damage, such as cracks, caused by vibrations over time), and/or costs may be provided to the reparability framework 450. The objective of the framework 450 may be to determine the optimized repair work-scope 460 that maximizes improvement in asset performance metrics after a repair shop visit at minimal cost. To achieve such a result, the reparability framework 450 may identify relationships between repairs, asset performance, and system health. The reparability framework 450 may probabilistically quantify effects (instead of using a subjective or categorical quantification) and use remote monitoring and repair shop visit data to determine beforehand what type of repair technology can have the most desirable effect on the asset performance metrics.

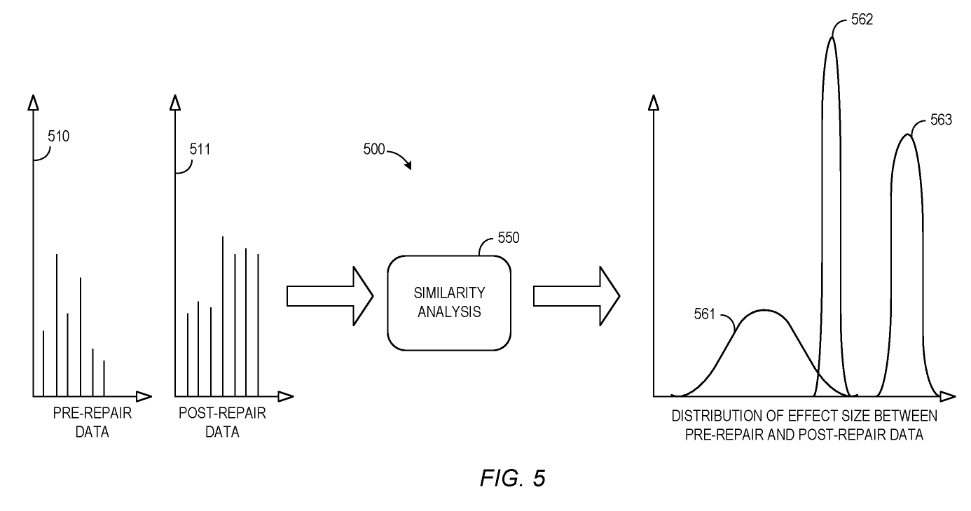

Consider, for example, FIG. 5 which illustrates 500 information associated with a similarity analysis 550 in accordance with some embodiments. In particular, pre-repair data 510 and post-repair data 511 may be input to the similarity analysis 550. According to some embodiments, an asset repair may have an effect on a chosen performance metric if sensor data before and after the repair is significantly different. In some cases, a t-test may measure if the two sets of data are statistically similar (although full probabilistic analogues of the t-test statistic may be more desirable).

Note that the similarity analysis 550 might be associated with, for example, a t-test statistic, a probabilistic analog of the t-test statistic, a Bayesian estimation, a t distribution, a highest density interval, an effect size interpretation, and/or an artificial neural network model to generate a mean μ_{ES} and a square of the standard deviation σ²_{ES}. The distribution of effect size between the pre-repair data and post-repair data may include results where the system is very confident that data before and after the repair are different 563, results where the system is very confident that data before and after the repair are similar 562, and results where the system is less confident that data before and after the repair are different 561. Thus, a similarity metric may be used to quantify an effect of a repair on asset performance. For example, RMD data may probabilistically quantify an improvement in performance metrics, such as vibrations, discharge temperature, and pressure after a shop visit or maintenance outage. According to some embodiments, the effect of a repair may be predicted based only on operational data (that is, operational data may be used to predict how effective a particular component repair will be for a specific asset). Moreover, models may be used to determine an optimal set of repair methods that will maximize improvement in performance metrics.

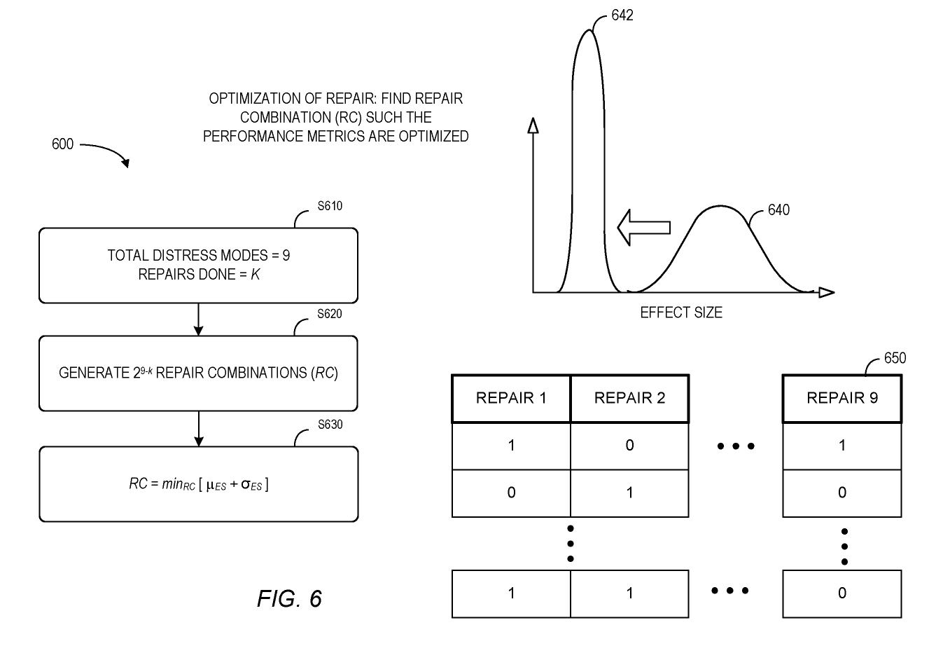

FIG. 6 illustrates repair optimization 600 according to some embodiments. The repair optimization 600 may, for example, find an optimum repair combination such that one or more performance metrics (e.g., vibration) are minimized. At S610, it is determined that a total number of distress modes is 9 and a number of repairs done is K. The system may then, at S620, generate 2^{9-K} sets of potential Repair Combinations (RC) using a model that maximizes improvement in post-repair performance metrics for the specific industrial asset. According to some embodiments, the system may score each RC at S630 as follows:

8RC=min_{RC}function(μ_{ES},σ_{ES})

where μ_{ES} represent a mean of an effect size interpretation and σ_{ES} represents a standard deviation of the effect size interpretation. As a result, all potential RC 650 may be analyzed to improve an effect size from before and after a repair 640 to an effect size before repair and after the optimized repair 642. Optimizing repair work-scope may improve Return On Investment (“ROI”) and reduce redundant component repairs over multiple shop visits. Moreover, it may be important to probabilistically quantify improvements in performance metrics after component repairs in a shop visit, and data-driven as well as physics-based hybrid models may better emulate relationships between effect of repairs and usage data (as compared to, for example operator judgement). Moreover, repair methods may be selected such that they have a maximum effect on asset performance with minimum cost.

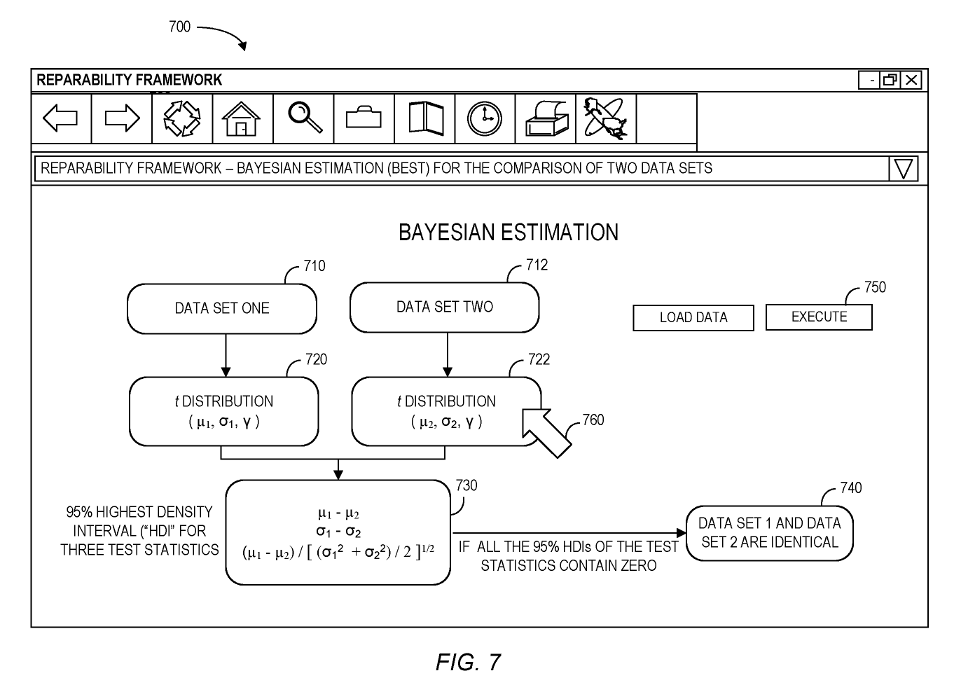

FIG. 7 illustrates an interactive graphical user interface Bayesian estimation (“BEST”) display 700 according to some embodiments. The display 700 may facilitate a comparison of two data sets 710, 712. Note that selection of icons 750 or a display element by a computer pointer 760 may result in execution of equations and or models, the display of further details about an element, and/or initiate adjustments to a display element. The first data set 710 is used to calculate a t distribution (μ₁, σ₁, y₁) 720 and the second data set 712 is used to calculate a t distribution (μ₂, σ₂, y₂) 722. These t distributions 720, 722 may then be used to calculate the following set of statistics 730:

μ₁−μ₂;

σ₁−σ₂; and

f(μ₁,μ₂,σ₁,σ₂).

These might be associated with, for example the 95% Highest Density Interval (“HDI”) for the three test statistics 730. If all of the 95% HDI of the test statistics 730 contain zero, then it may be determined that data set one 710 and data set two 712 are identical at 740.

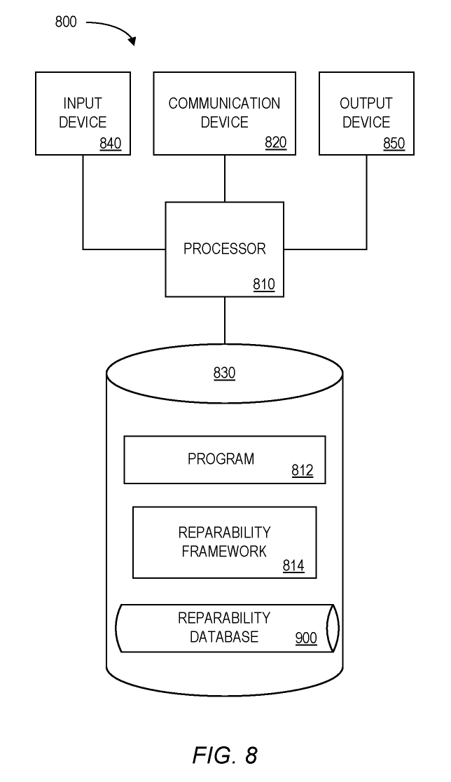

The embodiments described herein may be implemented using any number of different hardware configurations. For example, FIG. 8 is block diagram of a reparability framework platform 800 that may be, for example, associated with the system 100 of FIG. 1 and/or the system 300 of FIG. 3. The reparability framework platform 800 comprises a processor 810, such as one or more commercially available Central Processing Units (“CPUs”) in the form of one-chip microprocessors, coupled to a communication device 820 configured to communicate via a communication network (not shown in FIG. 8). The communication device 820 may be used to communicate, for example, with one or more remote operator platforms or asset sensors. The diagnosis model creation platform 800 further includes an input device 840 (e.g., a computer mouse and/or keyboard to input repair or modeling information) and/an output device 850 (e.g., a computer monitor to render displays, transmit repair recommendations, and/or create reports). According to some embodiments, a mobile device, cloud-based application, and/or PC may be used to exchange information with the diagnosis model creation platform 800.

The processor 810 also communicates with a storage device 830. The storage device 830 may comprise any appropriate information storage device, including combinations of magnetic storage devices (e.g., a hard disk drive), optical storage devices, mobile telephones, and/or semiconductor memory devices. The storage device 830 stores a program 812 and/or a reparability framework process 814 for controlling the processor 810. The processor 810 performs instructions of the programs 812, 814, and thereby operates in accordance with any of the embodiments described herein. For example, the processor 810 may receive information associated with operation of a set of industrial assets, including pre-repair and post-repair performance metrics for the industrial assets. The processor 810 may execute a similarity analysis on the pre-repair and post-repair performance metrics for the industrial assets to probabilistically quantify improvement in performance metrics as a result of a repair. The processor 810 may also predict an effect of a repair on a specific industrial asset based at least in the quantified improvement in performance metrics. The processor 810 may then automatically generate at least one asset repair recommendation for the specific industrial asset, based at least in part on the predicted effect, and transmit information associated with the at least one asset repair recommendation for the specific industrial asset (e.g., via the communication device 820).

The programs 812, 814 may be stored in a compressed, uncompiled and/or encrypted format. The programs 812, 814 may furthermore include other program elements, such as an operating system, clipboard application, a database management system, and/or device drivers used by the processor 810 to interface with peripheral devices.

As used herein, information may be “received” by or “transmitted” to, for example: (i) the reparability framework platform 800 from another device; or (ii) a software application or module within the reparability framework platform 800 from another software application, module, or any other source.

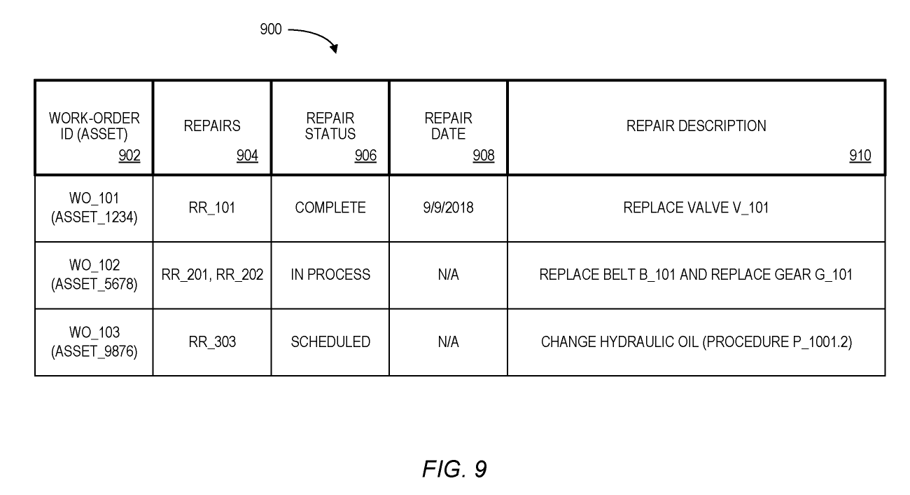

In some embodiments (such as the one shown in FIG. 8), the storage device 830 further stores a reparability database 900. An example of a database that may be used in connection with the reparability framework platform 800 will now be described in detail with respect to FIG. 9. Note that the database described herein is only one example, and additional and/or different information may be stored therein. Moreover, various databases might be split and/or combined without other databases or programs in accordance with any of the embodiments described herein.

Referring to FIG. 9, a table is shown that represents the reparability database 900 that may be stored at the reparability framework platform 800 according to some embodiments. The table may include, for example, entries identifying work-orders that might be automatically generated for an industrial asset. The table may also define fields 902, 904, 906, 909, 910 for each of the entries. The fields 902, 904, 906, 909, 910 may, according to some embodiments, specify: a work-order identifier 902 (for a specific industrial asset), repairs 904, a repair status 906, a repair date 908, and a repair description 910. The reparability database 900 may be created and updated, for example, when input data is imported into the system (e.g., performance metrics), a new airplane or engine is to be modeled, repairs are performed, metrics are collected, etc.

The work-order identifier 902 may be, for example, a unique alphanumeric code identifying a particular set of repairs 904 that are recommended for a specific industrial asset (e.g., an “aviation” asset). The repair status 906 might indicate whether or not those repairs 904 have been performed. The repair date 908 might indicate when the repairs were performed, and the repair description 910 might describe details about the repair (e.g., which parts were replaced, which procedures were executed, etc.). The information in the reparability database 900 may then be used to automatically create a reparability framework model and/or to monitor future performance of the specific industrial asset according to any of the embodiments described herein.

Thus, some embodiments may provide an automatic and efficient way to make repair recommendations in an accurate manner. Some embodiments described herein may provide simpler, safer, and/or more cost effective operation and maintenance of an industrial asset.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

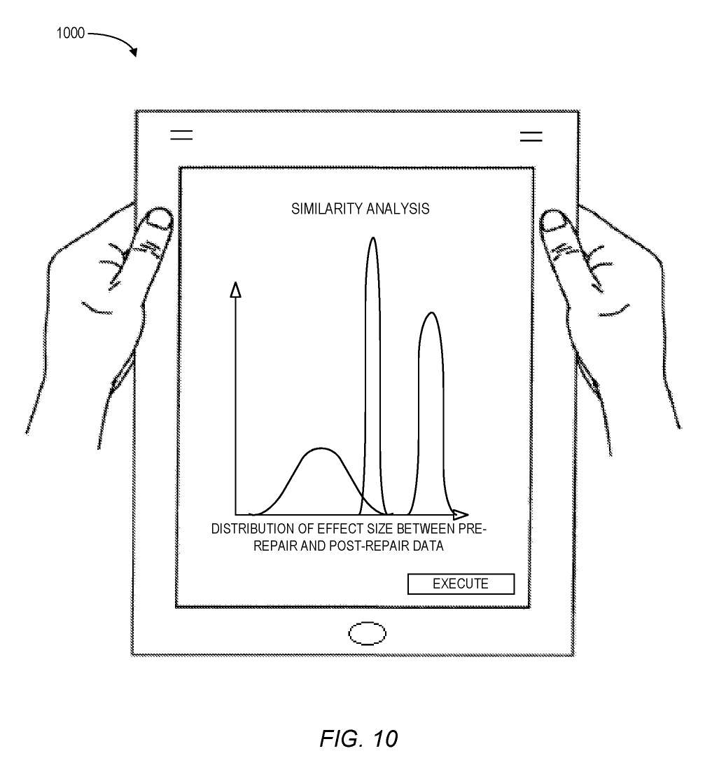

Although specific hardware and data configurations have been described herein, note that any number of other configurations may be provided in accordance with embodiments of the present invention (e.g., some of the information associated with the databases described herein may be combined or stored in external systems). For example, although some embodiments are focused on aircraft systems, embodiments might be associated with power plants, locomotives, or any other type of industrial asset. Moreover, although sample displays have been provided as illustrations, note that embodiments might utilize any other type of display, including virtual reality, augmented reality, and mobile computers. For example, FIG. 10 illustrates an interactive handheld graphical user interface display 1000 according to some embodiments. The display 1000 might provide, for example, a graphical representation of a similarity analysis in accordance with any of the embodiments described herein.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with industrial asset repairs, comprising:
an input communications port to receive information associated with operation of a set of industrial assets, including pre-repair and post-repair performance metrics for the industrial assets;
a reparability framework processing unit, coupled to the input communications port, to:
execute a similarity analysis on the pre-repair and post-repair performance metrics for the industrial assets to probabilistically quantify improvement in performance metrics as a result of a repair,
predict an effect of a repair on a specific industrial asset based at least in the quantified improvement in performance metrics, and
automatically generate at least one asset repair recommendation for the specific industrial asset based at least in part on the predicted effect; and
an output communications port coupled to the reparability framework processing unit to transmit information associated with the at least one asset repair recommendation for the specific industrial asset.

2. The system of claim 1, wherein the information associated with the operation of the set of industrial assets includes remote monitoring diagnostics data.

3. The system of claim 2, wherein the information associated with the operation of the set of industrial assets further includes at least one of: (i) distress modes, (ii) cost information, (iii) efficiency information, (iv) sensor data, and (v) data collected while an industrial asset is being repaired.

4. The system of claim 1, wherein the at least one asset repair recommendation is generated to maximize post-repair industrial asset performance metrics for the specific industrial asset at a minimized cost.

5. The system of claim 1, wherein the transmitted information comprises a work-scope that includes information associated with a plurality of repair recommendations for the specific industrial asset, including a first repair recommendation and a second repair recommendation, the second repair recommendation being selected based at least in part on the generation of the first repair recommendation.

6. The system of claim 5, wherein the plurality of repair recommendations are selected from a set of potential Repair Combinations (RC) using a model that maximizes improvement in post-repair performance metrics for the specific industrial asset.

7. The system of claim 6, wherein d represents a number of distress modes for the specific industrial asset, r represents a number of repairs, and the number of RCs is 2^{d-k}.

8. The system of claim 7, wherein each RC is scored as follows:
RC=min_{RC}function(μ_{ES},σ_{ES})
where μ_{ES} represent a mean of an effect size interpretation and σ_{ES} represents a standard deviation of the effect size interpretation.

9. The system of claim 1, wherein the similarity analysis is associated with at least one of: (i) a t-test statistic, (ii) a probabilistic analog of the t-test statistic, (iii) a Bayesian estimation, (iv) a t distribution, (v) a highest density interval, (vi) an effect size interpretation, and (vii) an artificial neural network model to generate a mean μ_{ES} and a square of the standard deviation σ²_{ES}.

10. The system of claim 9, wherein the similarity analysis is associated with an effect size interpretation such that:
if a relatively high mean μ_{ES} is determined along with a relatively low standard deviation σ_{ES}, then the analysis determines that the repair had a relatively large effect, and
if a relatively low mean μ_{ES} is determined or a relatively high standard deviation σ_{ES} is determined, then the analysis determines that the repair had a relatively small effect.

11. A computerized method associated with industrial asset repairs, comprising:
receiving information associated with operation of a set of industrial assets, including pre-repair and post-repair performance metrics for the industrial assets;
executing, by a reparability framework processing unit, a similarity analysis on the pre-repair and post-repair performance metrics for the industrial assets to probabilistically quantify improvement in performance metrics as a result of a repair;
predicting an effect of a repair on a specific industrial asset based at least in the quantified improvement in performance metrics;
automatically generating at least one asset repair recommendation for the specific industrial asset based at least in part on the predicted effect; and
transmitting information associated with the at least one asset repair recommendation for the specific industrial asset.

12. The method of claim 11, wherein the information associated with the operation of the set of industrial assets includes remote monitoring diagnostics data.

13. The method of claim 12, wherein the information associated with the operation of the set of industrial assets further includes at least one of: (i) distress modes, (ii) cost information, (iii) efficiency information, (iv) sensor data, and (v) data collected while an industrial asset is being repaired.

14. The method of claim 14, wherein the at least one asset repair recommendation is generated to maximize post-repair industrial asset performance metrics for the specific industrial asset at a minimized cost.

15. The method of claim 15, wherein the transmitted information comprises a work-scope that includes information associated with a plurality of repair recommendations for the specific industrial asset, including a first repair recommendation and a second repair recommendation, the second repair recommendation being selected based at least in part on the generation of the first repair recommendation.

16. The system of claim 14, wherein the plurality of repair recommendations are selected from a set of potential Repair Combinations (RC) using a model that maximizes improvement in post-repair performance metrics for the specific industrial asset.

17. The system of claim 16, wherein d represents a number of distress modes for the specific industrial asset, r represents a number of repairs, and the number of RCs is 2^{d-k}.

18. The system of claim 17, wherein each RC is scored as follows:
RC=min_{RC}[function(μ_{ES}+σ_{ES})]
where μ_{ES} represent a mean of an effect size interpretation and σ_{ES} represents a standard deviation of the effect size interpretation.

19. A non-transitory, computer-readable medium storing instructions that, when executed by a computer processor, cause the computer processor to perform a method associated with industrial asset repair, the method comprising:
receiving information associated with operation of a set of industrial assets, including pre-repair and post-repair performance metrics for the industrial assets;
executing, by a reparability framework processing unit, a similarity analysis on the pre-repair and post-repair performance metrics for the industrial assets to probabilistically quantify improvement in performance metrics as a result of a repair;
predicting an effect of a repair on a specific industrial asset based at least in the quantified improvement in performance metrics;
automatically generating at least one asset repair recommendation for the specific industrial asset based at least in part on the predicted effect; and
transmitting information associated with the at least one asset repair recommendation for the specific industrial asset.

20. The medium of claim 19, wherein the similarity analysis is associated with at least one of: (i) a t-test statistic, (ii) a probabilistic analog of the t-test statistic, (iii) a Bayesian estimation, (iv) a t distribution, (v) a highest density interval, (vi) an effect size interpretation, and (vii) an artificial neural network model to generate a mean μ_{ES} and a square of the standard deviation σ²_{ES}.

21. The medium of claim 20, wherein the similarity analysis is associated with an effect size interpretation such that:
if a relatively high mean μ_{ES} is determined along with a relatively low standard deviation σ_{ES}, then the analysis determines that the repair had a relatively large effect, and
if a relatively low mean μ_{ES} is determined or a relatively high standard deviation σ_{ES} is determined, then the analysis determines that the repair had a relatively small effect.
